(19) United States
(12) Patent Application Publication
(10) Pub. No.: US 2011/0100269 A1
(43) Pub. Date: May 5, 2011

(54) Configurable And Securable Table Cover Assembly

(76) Inventor: Carleton Eugene Hull, Las Vegas, NV (US)

(21) Appl. No.: 12/611,129

(22) Filed: Nov. 3, 2009

(51) Int. Cl. A47B 13/08; A47B 97/00; A47G 11/00; B31D 1/00

(52) U.S. Cl. 108/90; 493/393

(57) ABSTRACT

A table cover assembly for covering a table-top is provided. The table cover assembly comprises a flexible table cover, one or more cords, and locking elements. The flexible table cover is configured to be securely and immovably positioned on table-tops having a shape generally similar to the shape of the flexible table cover. The flexible table cover comprises one or more layers affixed to one another to create the flexible table cover. The flexibly table cover is hemmed around its periphery. The hemmed periphery defines an interstitial cavity extending along the hemmed periphery for inserting a cord which can be tightened and locked using the locking elements, for positioning the flexible table cover on the table-top to provide a secure, immovable and smooth surface on the table-top. The flexible table cover allows guidable and bounceable movement of articles placed on the flexible table cover covering the table-top.

### BACKGROUND

A table cover is used for covering a table-top. Table covers are made of different materials, for example, nylon, polyurethane, polyethylene, canvas, or rubber based on the environment it is being utilized. A table cover is typically used to cover table-tops in both indoor and outdoor environments. The table cover used for covering the table-top is typically of a particular shape and size and is generally made of materials that are rough and do not allow movement of articles placed on the table-top.

A table cover of a particular shape cannot be configured to table-tops of different shapes and sizes. Therefore, multiple table covers are required for table-tops of different shapes and sizes. Moreover, traditional table covers cannot be locked or secured in place over the table-top and may easily slip off the table, crease, ripple or fold while an activity, for example, a game is being played on the table. In addition, typical table covers do not allow a player to play a table-top game with articles on the table-top under control of the player. Furthermore, traditional table covers cannot immovably and securely enclose table-tops across the entire upper surface and sides of the table-top.

Hence, there is a need for a table cover assembly that can be configured to the shape and size of table-tops of different shapes and can be immovably secured in place to allow controlled movement of articles placed on the table-top.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The table cover assembly and method disclosed herein addresses the above stated needs for covering table-tops of generally the same shape or configuration with one generally similar shaped table cover. The table cover assembly disclosed herein can be immovably secured in place over the table-top and allows controlled movement of articles placed on the table-top.

The table cover assembly disclosed herein comprises a flexible table cover, one or more cords, and one or more locking elements. The flexible table cover is reversibly configurable to a shape and size of a table-top for covering the table-top. The flexible table cover comprises one or more layers of a flexible material affixed to one another. In an embodiment, the flexible table cover comprises a first padding layer made of a first material, for example, neoprene, sandwiched between a second layer and a third layer each made of a second material, for example, polyester. The first padding layer, the second layer, and the third layer are affixed to one another, for example, by fusing, gluing, etc. to create the flexible table cover. In this embodiment, the third polyester layer would lay on the table-top, with the first neoprene layer above the third polyester layer, and with the second polyester layer forming the upper surface of the flexible table cover. The flexible table cover is hemmed around its periphery to define an interstitial cavity extending along the hemmed periphery for allowing insertion of one or more cords through the interstitial cavity. The hemmed periphery of the flexible table cover wraps around the edges of the table-top, thereby covering the table-top on all sides. In an embodiment, the flexible table cover is stretchable to wrap the edges of the table-top and conform to the shape of the table-top.

The cords, for example, bungee cords or stretchable pull cords, are inserted through the interstitial cavity of the flexible table cover. The inserted cords pass through the interstitial cavity of the flexible table cover with opposing ends of the inserted cords being drawn outwardly through openings of the interstitial cavity. The openings are defined along one or more opposing sections of the hemmed periphery. The inserted cords are pulled at each end till the flexible table cover securely encloses the table-top. The inserted cords drawn are then tensioned and locked in place by adjustable and slidable locking elements. The flexible table cover is thereby securely and immovably positioned over the table-top. The flexible table cover is immovably secured to the surface of the table-top without any bends, folds or creases on the table-top surface to allow guidable and bounceable movement of articles placed on the flexible table cover on the table-top.

In an embodiment, the locking elements are, for example, cord locks that adjustably lock opposing ends of the inserted cords drawn outwardly from the openings at the opposing sections of the hemmed periphery. The flexible table cover further comprises multiple article capture sections for capturing the articles placed on the flexible table cover that covers the table-top. The flexible table cover is configured to multiple shapes based on the shape of the table-top. The table cover assembly disclosed herein may also be used as a securable table pad for placement under linens for dining tables.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a bottom view of a table cover assembly for covering a table-top.

FIG. 2 exemplarily illustrates a three layered configuration of a flexible table cover of the table cover assembly.

FIG. 3 exemplarily illustrates a sectional view of a flexible table cover showing an interstitial cavity defined by a hemmed periphery for inserting a cord.

FIG. 4 exemplarily illustrates a bottom view of the table cover assembly showing a hemmed periphery of the flexible table cover with an interstitial cavity for passing a cord.

FIGS. 5A-5B exemplarily illustrate locking elements that adjustably lock the inserted cords drawn outwardly through the openings of the flexible table cover.

FIG. 6A exemplarily illustrates a bottom view of the table cover assembly for covering a rectangular shaped table-top.

FIG. 6B exemplarily illustrates a top view of the table cover assembly for covering a rectangular shaped table-top.

FIG. 7 exemplarily illustrates a top view of the table cover assembly with an octagonal center configured to the shape of a circular shaped table-top.

FIG. 8 exemplarily illustrates a top view of the table cover assembly with a hexagonal center configured to the shape of a circular shaped table-top.

FIG. 9 exemplarily illustrates the table cover assembly covering a rectangular shaped table-top.

FIG. 10 exemplarily illustrates the table cover assembly covering a circular shaped table-top.

FIG. 11 illustrates method of making the table cover assembly.

FIG. 12 illustrates method of covering a table-top using the table cover assembly.

### DETAILED DESCRIPTION OF THE INVENTION

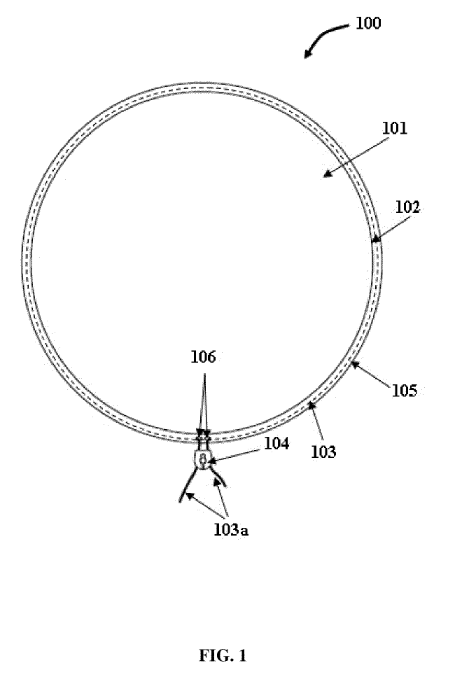

FIG. 1 illustrates a bottom view of a table cover assembly 100 for covering a table-top. The table cover assembly 100 disclosed herein comprises a flexible table cover 101, one or more cords 103, and one or more locking elements 104. For purposes of illustration, the detailed description refers to a single cord 103 and a single locking element 104; however the scope of the table cover assembly 100 is not limited to a single cord 103 and a single locking element 104 but may be extended to include multiple cords 103 and locking elements 104.

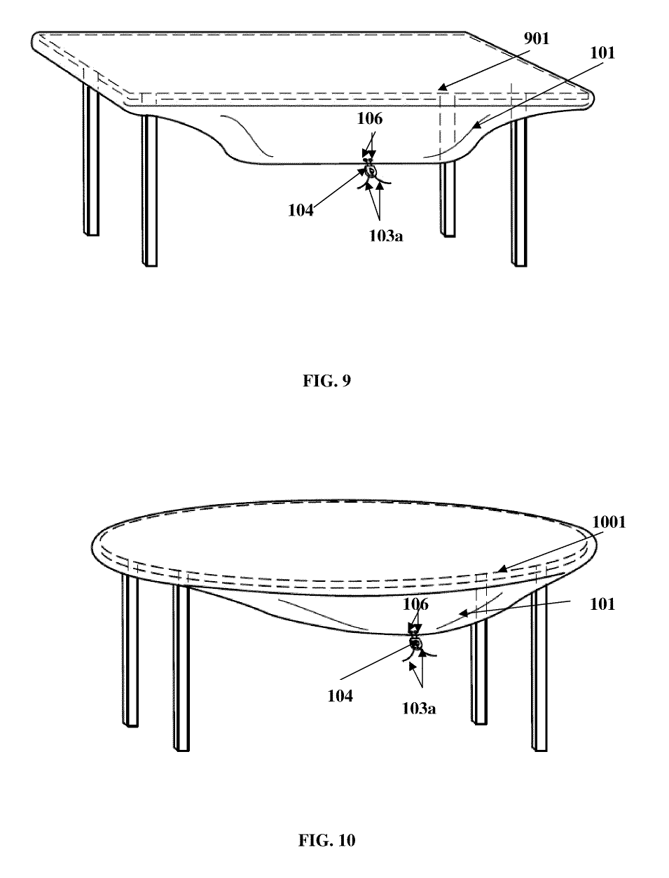

The flexible table cover 101 is reversibly configurable to a shape and size of a table-top 901 or 1001 for covering the table-top 901 or 1001. A rectangular shaped table-top 901 is exemplarily illustrated in FIG. 9 and a circular shaped table-top 1001 is exemplarily illustrated in FIG. 10. As used herein, the term “reversible” refers to the flexible table cover 101 that can be placed on the table-top 901 or 1001 on either of the flexible table cover's 101 surfaces and configured to the shape and size of the table-top 901 or 1001 on either of the flexible table cover's 101 surfaces. The table cover assembly 100 disclosed herein can be configured to the shape and size of a table-top 901 or 1001 and can be immovably secured on the table-top 901 or 1001. When the flexible table cover 101 is secured in place, the surface of the flexible table cover 101 lies flush with the surface of the table-top 901 or 1001 without any creases or ripples and allows controlled movement of articles placed or thrown on the table-top 901 or 1001. The table cover assembly 100 disclosed herein may also be used as a table pad. As illustrated in FIG. 1, the periphery 102 of the flexible table cover 101 is folded inwards and hemmed along the periphery 102 to create an interstitial cavity 105 extending along the hemmed periphery 102 for allowing a cord 103 to be inserted through the interstitial cavity 105 as disclosed in the detailed description of FIG. 3. The opposing ends 103a of the cord 103 exit the interstitial cavity 105 in the hemmed periphery 102 through centrally located openings 106 in the hemmed periphery 102.

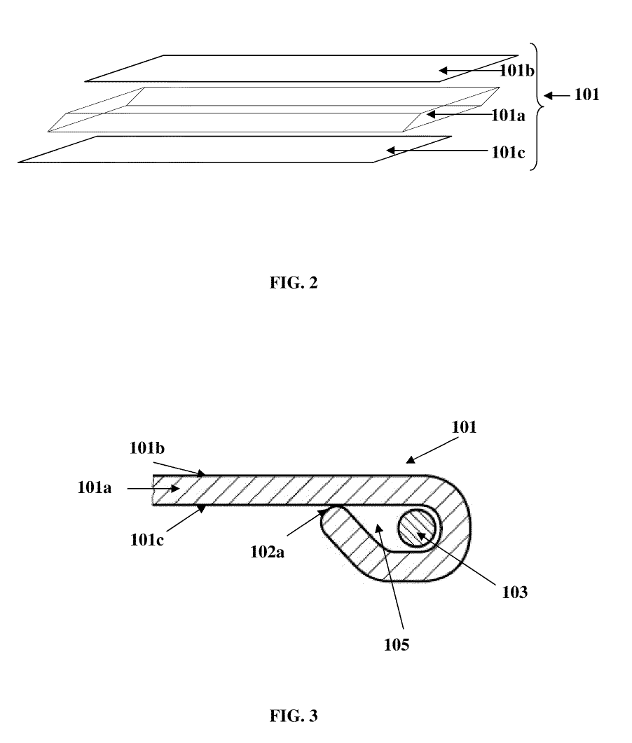

FIG. 2 exemplarily illustrates a three layered configuration of the flexible table cover 101 of the table cover assembly 100. The flexible table cover 101 comprises one or more layers 101a, 101b, and 101c, made of a flexible material that are affixed to one another. In an embodiment, the flexible table cover 101 comprises a first padding layer 101a made of a first material, for example, neoprene, sandwiched between a second layer 101b and a third layer 101c each made of a second material, for example, polyester. The first padding layer 101a, the second layer 101b, and the third layer 101c are affixed to one another, for example, by fusing, gluing, or other joining techniques, to create the flexible table cover 101 as exemplarily illustrated in FIG. 3. In this embodiment, the third polyester layer 101c would lay on the table-top 901 or 1001, with the first neoprene layer 101a above the third polyester layer 101c, and with the second polyester layer 101b forming the upper surface of the flexible table cover 101.

When the cord 103 is drawn or extended with the flexible table cover 101 positioned over the table-top 901 or 1001, the flexible table cover 101 is securely and immovably positioned on the table-top 901 or 1001 without any bends, creases, folds or ripples on the flexible table cover 101 on the surface of the table-top 901 or 1001. Once positioned on the table-top 901 or 1001, the flexible table cover 101 allows guidable and bounceable movement of articles placed on the flexible table cover 101 covering the table-top 901 or 1001, thereby allowing easy and controlled gliding and sliding of articles on the flexible table cove 101. The flexible table cover 101 provides protection for the table-top 901 or 1001 against accidents, water spills, etc. The flexible table cover 101 is reversibly configurable to cover and wrap a table-top 901 or 1001 of different shapes and sizes, for example, round, rectangular, octagonal, hexagonal, square, oval, etc. using a flexible table cover 101 of generally the same configuration as the shape of the table-top 901 or 1001. The flexible table cover 101 is stretchable to wrap the edges of the table-top 901 or 1001 and conform to the shape of the table-top 901 or 1001. The flexible table cover 101 is configured to cover generally like shaped table-tops. For example, a rectangular flexible table cover 101 can be configured to fit oval and rectangular shaped table-tops 901, and a circular shaped flexible table cover 101 can be configured to fit square, hexagonal, octagonal, and circular shaped table-tops 1001.

The flexible table cover 101 is securely and immovably wrapped around a table, for example, a dining table from edge to edge. The neoprene layer 101a ranges, for example, from about 1 mm and to about 3 mm in thickness. The three layered thickness of the flexible table cover 101 is about, for example, 2 mm to 4 mm.

In an embodiment, the flexible table cover 101 comprises layers made of two materials, for example, neoprene and polyester fused to each other, with the neoprene layer forming the lower surface of the flexible table cover 101 and the polyester layer forming the upper surface of the flexible table cover 101 on which articles or objects are placed.

In yet another embodiment, the flexible table cover 101 comprises a single sheet of flexible material, for example, a polyester or other plastic, a synthetic rubber, neoprene, etc.

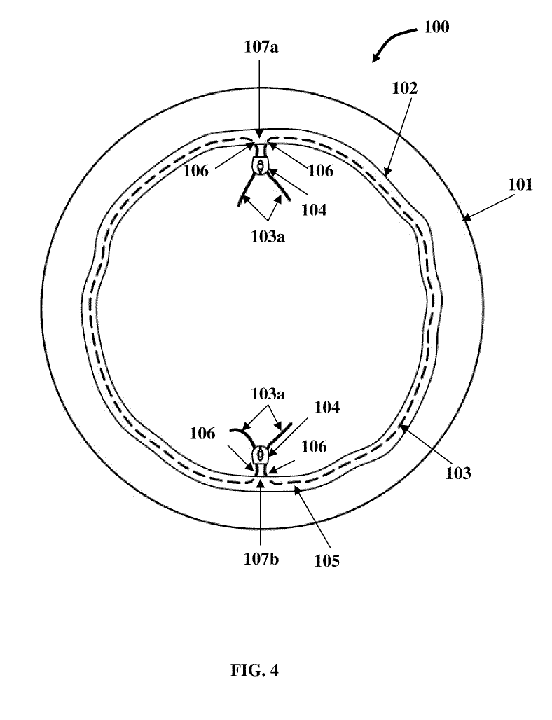

FIG. 3 exemplarily illustrates a sectional view of a flexible table cover 101 showing an interstitial cavity 105 defined by the periphery hemmed at 102a that extends along the periphery 102 of the flexible table cover 101 for insertion of the cord 103 through the interstitial cavity 105. The flexible table cover 101 made, for example, by fusing together the first padding layer 101a, the second layer 101b, and the third layer 101c, is folded and hemmed around its periphery 102. The hemmed periphery 102 defines an interstitial cavity 105 extending along the hemmed periphery 102 of the flexible table cover 101. The cord 103 is inserted through the interstitial cavity 105 of the flexible table cover 101. The inserted cord 103 passes through the interstitial cavity 105 and the opposing ends 103a of the inserted cord 103 are drawn outwardly through the openings 106 of the interstitial cavity 105 as exemplarily illustrated in FIG. 4. The cord 103 is, for example, a bungee cord or a stretchable pull cord, made of an elastic material.

FIG. 4 exemplarily illustrates a bottom view of the table cover assembly 100 showing a hemmed periphery 102 with an interstitial cavity 105 through which a cord 103 is threaded. The hemmed periphery 102 wraps around the edge of the table-top 901 or 1001. For example, the flexible table cover 101 is cupped along the hemmed periphery 102 to fit around the edge of the table-top 901 or 1001. The hemmed periphery 102 is adjustable based on dimensions of the table-top 901 or 1001. The hemmed periphery 102 adjusts proportionally as the diameter of the table-top 901 and 1001 changes. As disclosed in the detailed description of FIG. 3, the cord 103 is inserted along the stitched hem 102. The opposing ends 103a of the cord 103 exit the stitched hem 102 through centrally located openings 106 in the stitched hem 102. The openings 106 of the interstitial cavity 105 are defined along opposing sections 107a and 107b of the hemmed periphery 102. In an embodiment, the openings 106 of the interstitial cavity 105 are defined along only one section 107a or 107b of the hemmed periphery 102.

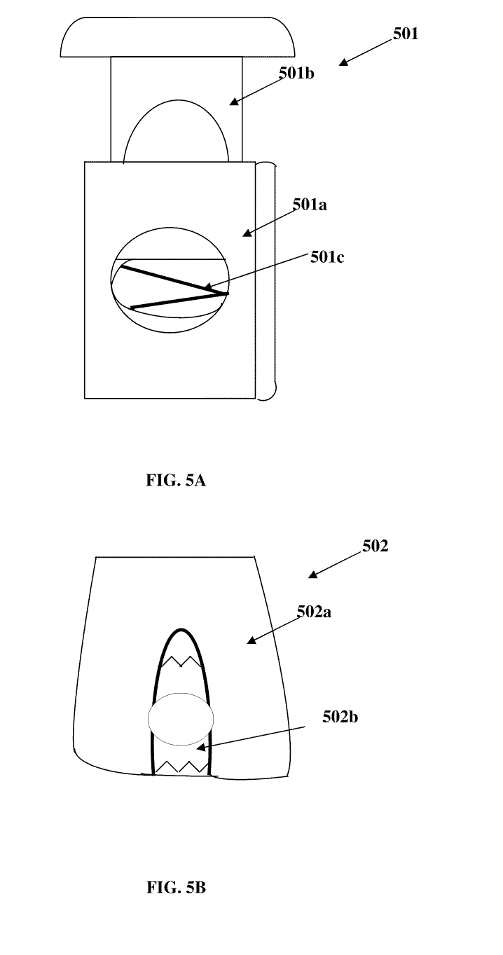

When the opposing ends 103a of the cord 103. are pulled or tensioned to draw the flexible table cover 101 taut over the surface of the table-top 901 or 1001, one or more locking elements 104 adjustably lock the inserted cord 103 drawn outwardly through the openings 106 of the flexible table cover 101 to securely and immovably position the flexible table cover 101 over the table-top 901 or 1001. The opposing ends 103a of the cord 103 are drawn out of the openings 106 and pass through the locking element 104. In an embodiment, the locking elements 104 are, for example, cord locks that adjustably lock opposing ends 103a of the inserted cord 103 drawn outwardly from the openings 106 at the opposing sections 107a and 107b of the hemmed periphery 102. The cord locks are, for example, barrel type cord locks 501 as exemplarily illustrated in FIG. 5A, wheel cord locks 502 as exemplarily illustrated in FIG. 5B, or other cord fasteners. The barrel type cord lock 501, illustrated in FIG. 5A, comprises three parts, for example, a barrel 501a, a toggle 501b, and a spring 501c. When the barrel 501a, the toggle 501b, and the spring 501c are squeezed together, tension is released and the barrel type cord lock 501 can move freely up and down the opposing ends 103a of the cord 103 for adjustable positioning. When released, the tension is engaged and the barrel type cord lock 501 holds the cord 103 in place thereby securely tightening the flexible table cover 101 over the table-top 901 or 1001. The wheel cord lock 502 illustrated in FIG. 5B comprises a body 502a and a locking wheel 502b. The opposing ends 103a of the cord 103 engage the locking wheel 502b on opposing sides and can be adjustably positioned for tightening the flexible table cover 101 over the table-top 901 or 1001. In an embodiment, the opposing ends 103a of the tightened cord 103 drawn outwardly from the opposing sections 107a and 107b of the hemmed periphery 102 may be further secured by locking under the table.

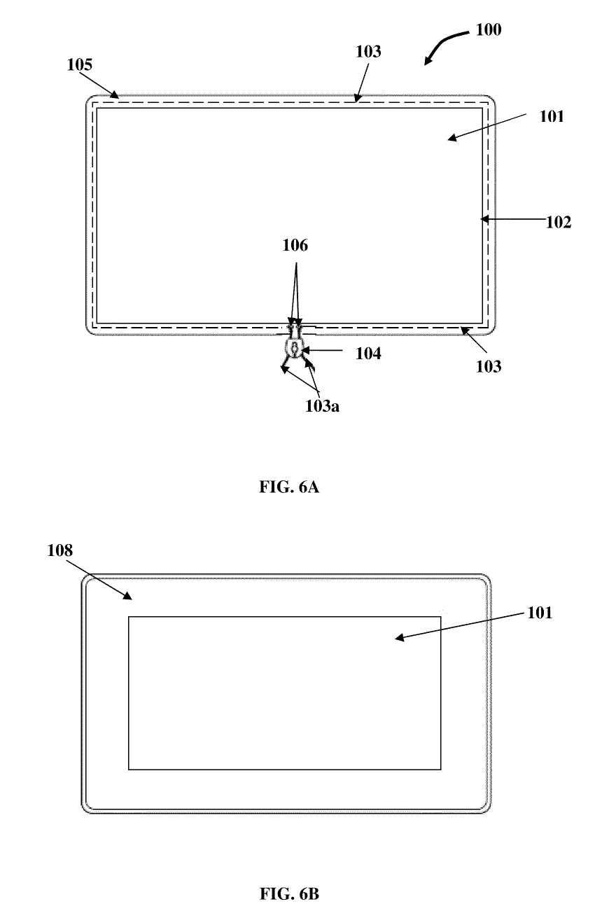

As disclosed in the detailed description of FIGS. 1-4, the flexible table cover 101 of the table cover assembly 100 is of a shape that generally corresponds to the shape of the table-top 901 or 1001. Table-tops 901 or 1001 of different shapes may be used for playing table-top games, for example, board games, coin games, card games such as poker, dice games, miniature games, paper and pencil games, tile based games, etc. When the flexible table cover 101 is positioned on the table-top 901 or 1001 as disclosed above, the flexible table cover 101 conforms itself to the shape of a variety of table-tops 901 and 1001 when the shape of the flexible table cover 101 is generally of a shape corresponding to the shape of the table-top 901 or 1001. For example, if the table-top 901 is of a rectangular shape, the flexible table cover 101 of the table cover assembly 100 used is generally of a rectangular shape to correspond to the rectangular shaped table-top 901 as exemplarily illustrated in FIGS. 6A-6B. FIG. 6A illustrate a bottom view of the table cover assembly 100 for covering a rectangular shaped table-top 901. The table cover assembly 100 illustrated in FIG. 6A covers a rectangular shaped table-top 901 and can be immovably secured to the surface of the table-top 901 by adjustably tightening and locking the cord 103 that exits the stitched hem 102 through the centrally located openings 106 in the stitched hem 102 under the rectangular shaped table-top 901. A top view of the table cover assembly 100 for covering the rectangular shaped table-top 901 is exemplarily illustrated in FIG. 6B.

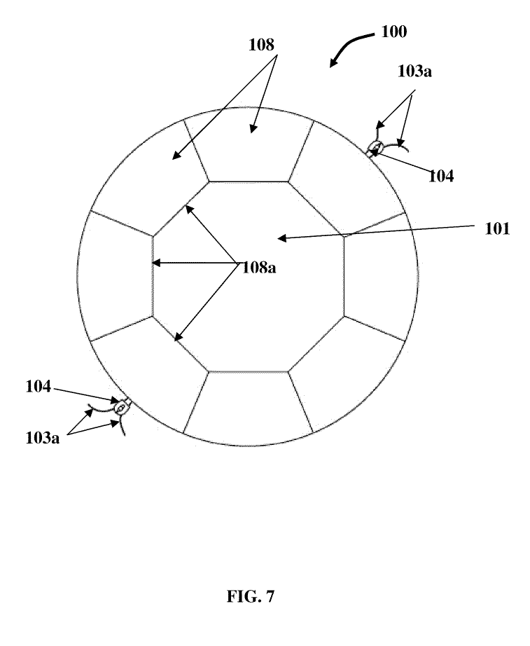

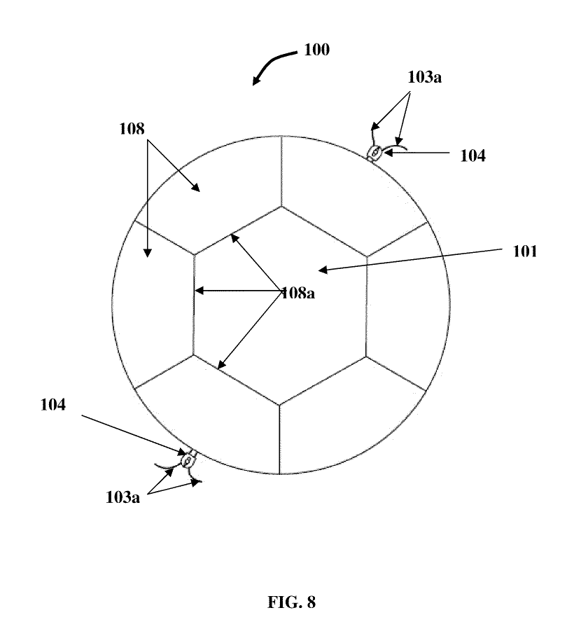

In an embodiment, the flexible table cover 101 further comprises article capture sections 108 for capturing articles, for example, poker chips, coins, cards, tokens, etc. placed, tossed or thrown on the flexible table cover 101 that covers the table-top 901 or 1001. The article capture sections 108 may be positioned on different parts on the flexible table cover 101 as exemplarily illustrated in FIG. 6B and FIGS. 7-8. For example, in FIG. 6B, an article capture section 108 is positioned along the rim of the rectangular shaped table-top 901. As illustrated in FIG. 7, the article capture sections 108 are positioned along the octagonal shaped center of the flexible table cover 101. The table cover assembly 100 with an octagonal center illustrated in FIG. 7 is configured to the shape of a circular shaped table-top 1001. FIG. 8 illustrates a top view of the table cover assembly 100 with a hexagonal center configured to the shape of a circular shaped table-top 1001. As illustrated in FIG. 8, the article capture sections 108 are positioned along the hexagonal shaped center of the flexible table cover 101. The article capture sections 108 are made of a material, for example, neoprene, that allows the articles to be easily captured and retained on the flexible table cover 101. The articles may also be captured at the seams 108a of the article capture sections 108 on the flexible table cover 101 as exemplarily illustrated in FIGS. 7-8.

The flexible table cover 101 allows the players at a table to guidably and bounceably move articles on the article capture sections 108 of the table cover assembly 100. The article capture sections 108 retain or catch articles thrown across on the flexible table cover 101 covering the table-top 901 or 1001. The article capture sections 108 may also be provided on player zones of the table-top 901 or 1001 as exemplarily illustrated in FIGS. 7-8. The table cover assembly 100 covering a rectangular shaped table-top 901 and a circular shaped table-top 1001 are exemplarily illustrated in FIG. 9 and FIG. 10 respectively.

Consider an example where a group of players sit around the table and play a table-top game, for example, poker. The table cover assembly 100 disclosed herein is wrapped over the table-top 901 or 1001 and secured using the locking element 104. The flexible table cover 101 of a shape generally corresponding to the shape of the table-top 901 or 1001 is positioned and secured to the table-top 901 or 1001 using the cord 103 and the locking element 104. When articles, for example, cards, coins, chips, etc. are placed on the article capture sections 108 of the flexible table cover 101, the flexible table cover 101 grips and holds the articles at the article capture sections 108. As the players begin to play the table-top game, the materials of the flexible table cover 101 provide a smooth and a flat surface for gliding and bouncing the articles over the surface of the table-top 901 or 1001. For example, the flexible table cover 101 allows playing cards that are dealt to glide and be picked up readily by a player seated at the table. The players therefore enjoy the flexibility and convenience of the securely positioned table cover assembly 100 on the table-top 901 or 1001 when the game is played.

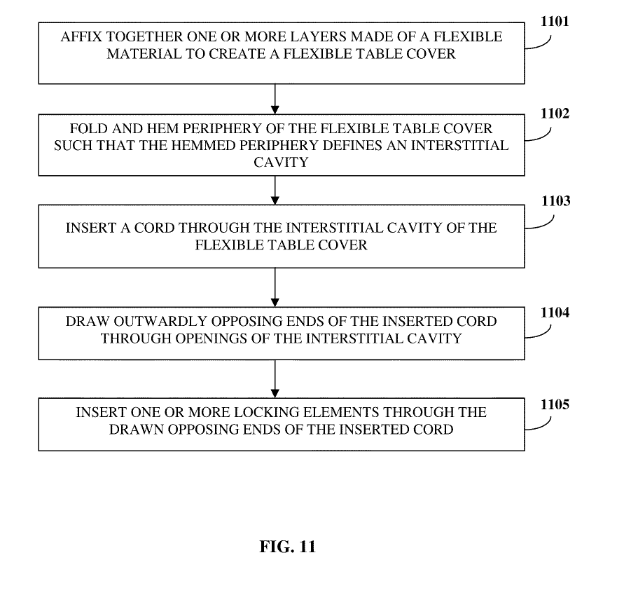

FIG. 11 illustrates method of making the table cover assembly 100. One or more layers, for example, 101a, 101b, and 101c, of a flexible material are affixed 1101 together to create the flexible table cover 101. For example, a first padding layer 101a made of a first material, for example, neoprene, is sandwiched between a second layer 101b and a third layer 101c each made of a second material, for example, polyester, nylon, etc. and affixed together, for example, by fusing, gluing and other joining techniques. The periphery 102 of the flexible table cover 101 is folded and hemmed 1102. The hemmed periphery 102 defines an interstitial cavity 105 extending along the hemmed periphery 102 of the flexible table cover 101. A cord 103 is inserted 1103 through the interstitial cavity 105 of the flexible table cover 101. The inserted cord 103 passes through the interstitial cavity 105. The opposing ends 103a of the inserted cord 103 is drawn 1104 outwardly through openings 106 of the interstitial cavity 105, the openings 106 being defined along one or more opposing sections 107a and 107b of the hemmed periphery 102. One or more locking elements 104 are then inserted 1105 through the drawn opposing ends 103a of the inserted cord 103. The inserted locking elements 104 adjustably lock the inserted cord 103 drawn outwardly through the openings 106 of the flexible table cover 101. The table cover assembly 100 disclosed herein comes fully assembled and a customer does not have to fish cord through the interstitial cavity 105 of the flexible table cover 101.

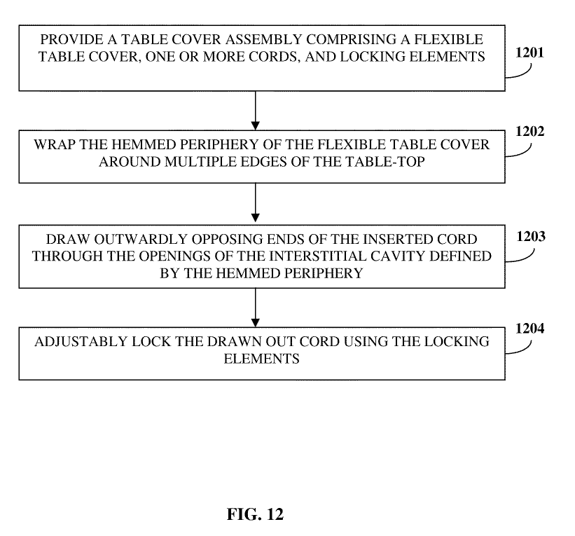

FIG. 12 illustrates a method of covering a table-top 901 or 1001. A table cover assembly 100 as disclosed in the detailed description of FIGS. 1-10 is provided 1201. The hemmed periphery 102 of the flexible table cover 101 is wrapped 1202 around multiple edges of the table-top 901 or 1001. The opposing ends 103a of the cord 103 that is inserted through the interstitial cavity 105 of the flexible table cover 101 during its making, are then drawn 1203 outwardly through the openings 106 of the interstitial cavity 105 till the flexible table cover 101 is positioned without any bends, folds, or creases over the surface of the table-top 901 or 1001. The drawn out cord 103 is then adjustably locked 1204 using one or more locking elements 104 for securely and immovably positioning the flexible table cover 101 over the table-top 901 or 1001. The flexible table cover 101 is immovably secured to the surface of the table-top 901 or 1001 without any bends, folds or creases on the table-top surface to allow guidable and bounceable movement of articles placed on the flexible table cover 101 on the table-top 901 or 1001.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A table cover assembly comprising:
a flexible table cover reversibly configurable to a shape and size of a table-top for covering said table-top, said flexible table cover comprising one or more layers of a flexible material affixed to one another, said flexible table cover hemmed around its periphery, wherein said hemmed periphery defines an interstitial cavity extending along said hemmed periphery of said flexible table cover to allow one or more cords to be inserted through said interstitial cavity, wherein said hemmed periphery wraps around a plurality of edges of said table-top;
said one or more cords inserted through said interstitial cavity of said flexible table cover, wherein said inserted one or more cords pass through said interstitial cavity with opposing ends of said inserted one or more cords being drawn outwardly through openings of said interstitial cavity, said openings being defined along one or more opposing sections of said hemmed periphery; and
one or more locking elements that adjustably lock said inserted one or more cords drawn outwardly through said openings of said flexible table cover to securely and immovably position said flexible table cover over said table-top;
whereby said flexible table cover is immovably secured to the surface of said table-top without any bends, folds or creases on said table-top surface to allow guidable and bounceable movement of articles placed on said flexible table cover on said table-top.

2. The table cover assembly of claim 1, wherein said locking elements are cord locks that adjustably lock said opposing ends of said inserted one or more cords drawn outwardly from said openings at said one or more opposing sections of said hemmed periphery.

3. The table cover assembly of claim 1, wherein said flexible table cover further comprises article capture sections for capturing said articles placed on said flexible table cover that covers said table-top.

4. The table cover assembly of claim 1, wherein said layers of said flexible table cover comprise a first padding layer made of a first material sandwiched between a second layer and a third layer each made of a second material, wherein said first padding layer, said second layer, and said third layer are affixed to one another to create said flexible table cover.

5. The table cover assembly of claim 4, wherein said first material is neoprene and said second material is polyester.

6. The table cover assembly of claim 1, wherein said flexible table cover covers a plurality of table-top shapes.

7. The table cover assembly of claim 1, wherein said flexible table cover is configured to cover generally like shaped table-tops.

8. The table cover assembly of claim 1, wherein said flexible table cover is stretchable to wrap said edges of said table-top and conform to said shape of said table-top.

9. The table cover assembly of claim 1, wherein said hemmed periphery is adjustable based on dimensions of said table-top.

10. A method of making a table cover assembly, comprising:
affixing together one or more layers made of a flexible material to create a flexible table cover;
folding periphery of said flexible table cover and hemming said folded periphery, wherein said hemmed periphery defines an interstitial cavity extending along said hemmed periphery of said flexible table cover to allow one or more cords to be inserted through said interstitial cavity;
inserting said one or more cords through said interstitial cavity of said flexible table cover, wherein said inserted one or more cords pass through said interstitial cavity; and
drawing outwardly opposing ends of said inserted one or more cords through openings of said interstitial cavity, said openings being defined along one or more opposing sections of said hemmed periphery.

11. The method of claim 10, further comprising inserting one or more locking elements through said drawn opposing ends of said inserted one or more cords, wherein said inserted one or more locking elements adjustably lock said inserted one or more cords drawn outwardly through said openings of said flexible table cover.

12. A method of covering a table-top, comprising:
providing a table cover assembly comprising:
a flexible table cover reversibly configurable to a shape and size of a table-top for covering said table-top, said flexible table cover comprising one or more layers of a flexible material affixed to one another, said flexible table cover hemmed around its periphery, wherein said hemmed periphery defines an interstitial cavity extending along said hemmed periphery of said flexible table cover to allow one or more cords to be inserted through said interstitial cavity;
said one or more cords inserted through said interstitial cavity of said flexible table cover, wherein said inserted one or more cords pass through said interstitial cavity with opposing ends of said inserted one or more cords being drawn outwardly through openings of said interstitial cavity, said openings being defined along one or more opposing sections of said hemmed periphery; and
one or more locking elements that adjustably lock said inserted one or more cords drawn outwardly through said openings of said flexible table cover;
wrapping said hemmed periphery of said flexible table cover around a plurality of edges of said table-top;
drawing outwardly opposing ends of said inserted one or more cords through said openings of said interstitial cavity; and
adjustably locking said drawn out one or more cords using said one or more locking elements to securely and immovably position said flexible table cover over said table-top;
whereby said flexible table cover is immovably secured to the surface of said table-top without any bends, folds or creases on said table-top surface to allow guidable and bounceable movement of articles placed on said flexible table cover on said table-top.

13. The method of claim 12, wherein said layers of said flexible table cover comprise a first padding layer made of a first material sandwiched between a second layer and a third layer each made of a second material, wherein said first padding layer, said second layer, and said third layer are affixed to one another to create said flexible table cover.

14. The method of claim 12, further comprising providing a plurality of article capture sections on said flexible table cover for capturing said articles placed on said flexible table cover that covers said table-top.

15. The method of claim 12, further comprising configuring said flexible table cover to a plurality of shapes based on said shape of said table-top.

16. The method of claim 12, further comprising configuring said flexible table cover to cover generally like shaped table-tops.

17. The method of claim 12, further comprising stretching said flexible table cover to wrap said edges of said table-top and conform to said shape of said table-top.

18. The method of claim 12, further comprising positioning said flexible table cover on said table-top for allowing said guidable and bounceable movement of said articles placed on said flexible table cover that covers said table-top.
